(19) United States
(12) Patent Application Publication
(10) Pub. No.: US 2004/0183985 A1
(43) Pub. Date: Sep. 23, 2004

(54) Liquid crystal display apparatus

(75) Inventor: Yoshihisa Taguchi, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: Fujitsu Display Technologies Corporation

(21) Appl. No.: 10/801,224

(22) Filed: Mar. 16, 2004

(30) Foreign Application Priority Data
Mar. 20, 2003 (JP) 2003-078719

(51) Int. Cl. G02F 1/1345

(52) U.S. Cl. 349/151

(57) ABSTRACT

A liquid crystal display apparatus that can detect a signal in an input signal wire and perform tests by measuring the resistance of the wire even without any signal input substrate is disclosed. The liquid crystal display apparatus includes an almost quadrilateral liquid crystal panel having a liquid crystal display part and a plurality of first drive IC substrates. The first drive IC substrates are aligned along an edge of the liquid crystal panel and connected to the liquid crystal panel. Each first drive IC substrate has a first drive IC and further includes a through wire to connect between distinct terminals of a plurality of terminals aligned along an edge thereof, and a test pad is formed on a portion of the through wire.

### CROSS-REFERENCE TO RELATED APPLICATIONS

The present application is based on Japanese priority application No. 2003-078719 filed Mar. 20, 2003, the entire contents of which are hereby incorporated by reference.

### BACKGROUND OF THE INVENTION

1. Field of the Invention

The present invention generally relates to a liquid crystal display apparatus, and more particularly to a liquid crystal display apparatus that is configured to drive liquid crystal by connecting a liquid crystal panel to an insulation film substrate including a drive signal IC (Integrated Circuit).

2. Description of the Related Art

A liquid crystal display apparatus drives liquid crystal by supplying a drive signal to a thin film transistor on a liquid crystal panel. In recent years, a liquid crystal display apparatus using an active matrix substrate as a large-sized liquid crystal panel has been being developed.

An active matrix substrate is a liquid crystal panel where a large number of thin film transistors (TFT) are arranged on a glass substrate in the form of a matrix. The active matrix substrate supplies a source signal and a gate signal to each thin film transistor to drive the liquid crystal corresponding to the thin film transistor.

FIG. 1 is a plan view roughly showing an exemplary structure of a conventional liquid crystal display apparatus. A plurality of insulation film substrates 2-1 through 2-3 and 4-1 through 4-4 are coupled to X and Y directional edges of a liquid crystal panel 1 in accordance with the form of an active matrix substrate. For each of these insulation film substrates, a drive IC, which is collectively illustrated in FIG. 1 as the reference numeral 6-1, is connected to convert an input signal into a liquid crystal drive signal and supply the liquid crystal drive signal to the liquid crystal panel 1.

A Y substrate 3 is connected as a signal input substrate to the insulation film substrates 2-1 through 2-3 having respective gate drive ICs to supply an X axis (horizontal) directional signal. From the Y substrate 3, an input signal is supplied to the insulation film substrates 2-1 through 2-3. On the other hand, an X substrate 5 is connected as a signal input substrate to insulation film substrates 4-1 through 4-4 having respective source drive ICs to supply an Y axis (vertical) directional signal. From the X substrate 5, an input signal is supplied to the insulation film substrates 4-1 through 4-4.

FIG. 2 is a magnified plan view showing the insulation film substrate 2-1 in FIG. 1. The individual insulation film substrates 2-1 through 2-3 and 4-1 through 4-4 have the same structure, and only the insulation film substrate 2-1 is described below.

On the insulation film substrate 2-1, a gate drive IC 6-1 is mounted. The gate drive IC 6-1 is connected to input signal terminals 7 and output signal terminals 8 via wires patterned on the insulation film substrate 2-1. On one of the patterned wires connecting between the output signal terminals 8 and the gate drive IC 6-1, a test pad 9 having a width greater than that of the patterned wire is provided.

Since each patterned wire on the insulation film substrate has an extremely small width, the test pad 9 is formed to have a width greater than that of the patterned wire so as to realize easier contact with a test probe.

For example, it can be checked whether the gate drive IC 6-1 is normally operating by detecting both signals supplied to the input and output sides of the gate drive IC 6-1. Here, the output side signal can be detected through contact of the test pad 9 with the test probe. On the other hand, the input side signal can be detected through direct contact of a test probe with wires on the Y substrate 3. The Y substrate 3 is a signal input substrate, and each patterned wire on the Y substrate 3 has a width much greater than those of patterned wires on the insulation film substrate 2-1. Accordingly, a wire on the Y substrate 3 can be brought into contact with a test probe without any test pad.

Conventionally, some structures in which an input signal can be supplied to each drive IC without any signal input substrate have been presented and translated into practical applications. FIG. 3 is a plan view showing a liquid crystal display apparatus having a structure to supply an input signal to each of the gate drive ICs 6-1, 6-2 and 6-3 with no use of the Y substrate 3 as a signal input substrate.

Referring to FIG. 3, the illustrated liquid crystal display apparatus has no Y substrate as shown in FIG. 1. In such a structure, input signals to be supplied to the insulation film substrates 2-1 through 2-3 shown in FIG. 1 are supplied to an insulation film substrate 2A-1 via the X substrate 5 and wires patterned on the insulation film substrate 4-1 and the liquid crystal panel 1.

FIG. 4 is a magnified plan view showing the insulation film substrate 2A-1 in FIG. 3.

Referring to FIG. 4, a through wire 9 and input signal lines 10 are patterned on the insulation substrate 2-1. An input terminal 9a and an output terminal 9b are formed on respective ends of the through wire 9. Also, input terminals 10a and output terminals 10b are formed on respective ends of the input signal lines 10. The input signal lines 10 are connected to halfway input terminals of the gate drive IC 6-1.

Specifically, IC drive signals, such as an IC control signal and a reference power supply, are supplied to the gate drive IC 6-1 via the input signal lines 10. On the other hand, other signals unnecessary for the gate drive IC 6-1, such as a common electrode signal and a repair signal, are supplied again to the liquid crystal panel 1 via the through wire 9.

Similar wires are patterned on the insulation film substrate 2A-2 adjacent to the insulation film substrate 2A-1. An input signal supplied to the insulation film substrate 2A-1 is supplied to the through wire 9 and the input signal lines 10 on the insulation film substrate 2A-2 via the through wire 9 and the input signal lines 10 on the insulation film substrate 2A-1.

According to the above structure, it is possible to supply not only IC drive signals to the insulation film substrates 2A-1 through 2A-3 without via the Y substrate 3 but also signals to the liquid crystal panel 1 via the insulation film substrates 2A-1 through 2A-3.

Japanese Laid-Open Patent Applications No. 06-230749 and No. 2000-137239 disclose the related art of the above-mentioned technique.

In general, in the above-mentioned liquid crystal display apparatus, an insulation film substrate is connected to a liquid crystal panel by using anisotropically conductive resin. However, each electrode on such an insulation film substrate and such a liquid crystal panel has a width of 50 μm through 100 μm. Accordingly, even if the insulation film substrate is slightly mispositioned relative to the liquid crystal panel, there is a risk that a connection defect may occur.

Thus, it is preferable to examine a connection condition after connecting of the insulation film substrate to the liquid crystal panel. There is a test approach to, when liquid crystal is driven and an error occurs in the liquid crystal, check whether signals are normally flowing by detecting voltages of input side and output side wires of a drive IC thereof and a voltage of an input signal wire supplied to the liquid crystal panel.

In a case where the Y substrate 3 is provided as a signal input substrate as illustrated in FIG. 1, a relatively wide patterned wire on the Y substrate 3 can be used to detect an input signal. In a case of the structure without the Y substrate 3 shown in FIG. 3, however, only patterned wires on the liquid crystal panel 1 and the insulation film substrates 2-1 through 2-3 are used as the input signal wires connectable with a test probe and so on. Accordingly, it is difficult to have the contact with a test probe because of the small wire width of such patterned wires, and thus it is impossible to properly perform the test.

### SUMMARY OF THE INVENTION

It is a general object of the present invention to provide a liquid crystal display apparatus in which one or more the above-mentioned problems are eliminated.

A more specific object of the present invention is to provide a liquid crystal display apparatus that can detect a signal in an input signal wire and perform tests through measurement of a resistor even without use of a signal input substrate.

In order to achieve the above-mentioned objects, there is provided according to one aspect of the present invention a liquid crystal display apparatus, including: an almost quadrilateral liquid crystal panel having a liquid crystal display part; and a plurality of first drive IC substrates being aligned along an edge of the liquid crystal panel and connected to the liquid crystal panel, each of the plurality of first drive IC substrates having a first drive IC, wherein the first drive IC substrate comprises a through wire to connect between distinct terminals of a plurality of terminals aligned along an edge thereof, and a test pad is formed on a portion of the through wire.

In an embodiment of the present invention, the first drive IC substrate may further include an input signal wire to connect between distinct terminals of the plurality of terminals aligned along the edge thereof, the input signal wire being connected to an input terminal of the first drive IC substrate, and a test pad is formed on a portion of the input signal wire.

In an embodiment of the present invention, the test pad may be formed by widening a portion of a patterned wire including a through wire or an input signal wire compared to the other portion thereof.

In an embodiment of the present invention, the liquid crystal panel may include at least one wire to connect between through wires or input signal wires on adjacent ones of the plurality of first drive IC substrates.

In an embodiment of the present invention, the liquid crystal display apparatus may further include: a plurality of second drive IC substrates being aligned along an edge orthogonal to the edge of the liquid crystal panel connected to the plurality of first drive IC substrates and connected to the liquid crystal panel, each of the plurality of second drive IC substrates including a second drive IC; and a signal input substrate being connected to each of the plurality of second drive IC substrates, wherein a signal is supplied from the signal input substrate to the first IC drive substrate via a wire formed on the signal input substrate, one of the plurality of second drive ICs and the liquid crystal panel.

In an embodiment of the present invention, for each of the plurality of first drive IC substrates, one end of the through wire may be connected to an input terminal formed in an outside area of a line of IC signal output terminals formed on an edge side of the first drive IC substrate, and the other end of the through wire may be connected to an output terminal formed in the other outside area of the line of the IC signal output terminals.

In an embodiment of the present invention, for each of the plurality of first drive IC substrates, one end of the input signal wire may be connected to an input terminal formed in an outside area of a line of IC signal output terminals formed on an edge side of the first drive IC substrate, and the other end of the input signal wire may be connected to an output terminal formed in the other outside area of the line of the IC signal output terminals.

In an embodiment of the present invention, the liquid crystal panel may an active matrix substrate on which thin film transistors are formed and arranged in form of a matrix, and the first drive IC substrate may be an insulation film substrate and connected to the liquid crystal panel by using anisotropically conductive resin.

Additionally, there is provided according to another aspect of the present invention a liquid crystal display apparatus, including: an almost quadrilateral liquid crystal panel having a liquid crystal display part; and a plurality of first drive IC substrates being aligned along an edge of the liquid crystal panel and connected to the liquid crystal panel, each of the plurality of first drive IC substrates having a first drive IC, wherein the first drive IC substrate comprises an input signal wire to connect between distinct terminals of a plurality of terminals aligned along an edge thereof, the input signal wire being connected to an input terminal of the first drive IC, and a test pad is formed on a portion of the input signal wire.

According to one aspect of the present invention, since a test pad is formed in a through wire and/or an input signal wire on a drive IC substrate, it is possible to observe the waveform of an input signal and measure the resistance of the wires via the test pad. Even if a wire having an extremely small width is patterned on a drive IC substrate and the drive IC substrate is not connected to a signal input substrate, it is possible to easily connect a test probe or the like to an input signal wire and thereby perform tests on a liquid crystal display apparatus.

In addition, a liquid crystal display apparatus according to the present invention has a greater advantage, if the liquid crystal display apparatus is configured by forming a liquid crystal panel as an active matrix substrate, on which thin film transistors are formed and arranged in the form of a matrix, and forming the above first drive IC substrate as an insulation film substrate in connection with the liquid crystal panel.

Other objects, features and advantages of the present invention will become more apparent from the following detailed description when read in conjunction with the accompanying drawings.

### BRIEF DESCRIPTION OF THE DRAWINGS

FIG. 1 is a plan view roughly showing an exemplary structure of a conventional liquid crystal display apparatus;

FIG. 2 is a magnified plan view of an insulation film substrate in FIG. 1;

FIG. 3 is a plan view showing a liquid crystal display apparatus having a structure in which input signal are supplied to individual gate drive ICs without any signal input substrate;

FIG. 4 is a magnified plan view of an insulation film substrate in FIG. 3;

FIG. 5 is a plan view of a liquid crystal display apparatus according to one embodiment of the present invention;

FIG. 6 is a circuit diagram illustrating a transistor circuit on a liquid crystal panel in FIG. 5;

FIG. 7 is a magnified plan view showing an insulation film substrate in FIG. 5;

FIG. 8 is a magnified plan view of a test pad according to one embodiment of the present invention;

FIG. 9 is a cross-sectional view of an insulation film substrate with respect to a test pad formation portion; and

FIG. 10 is a diagram to explain a test method for the liquid crystal display apparatus in FIG. 5.

### DETAILED DESCRIPTION OF THE PREFERRED EMBODIMENTS

In the following, embodiments of the present invention will be described with reference to the accompanying drawings.

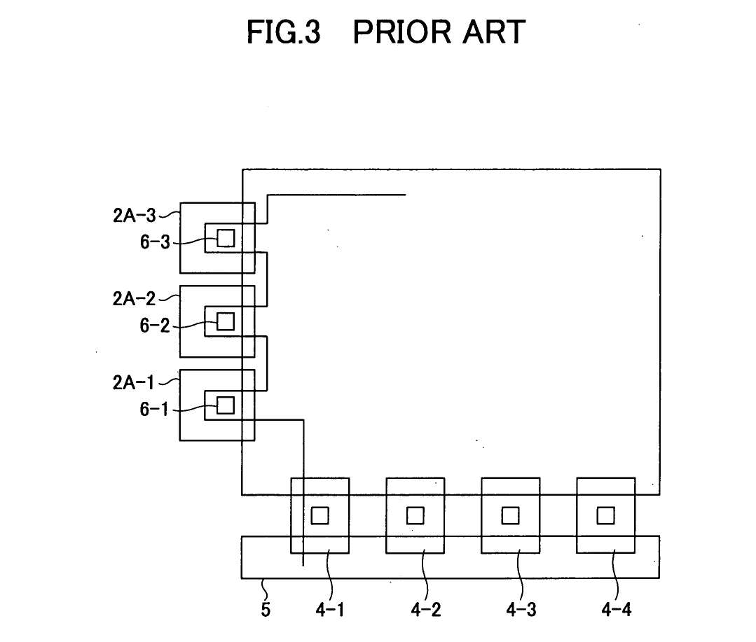

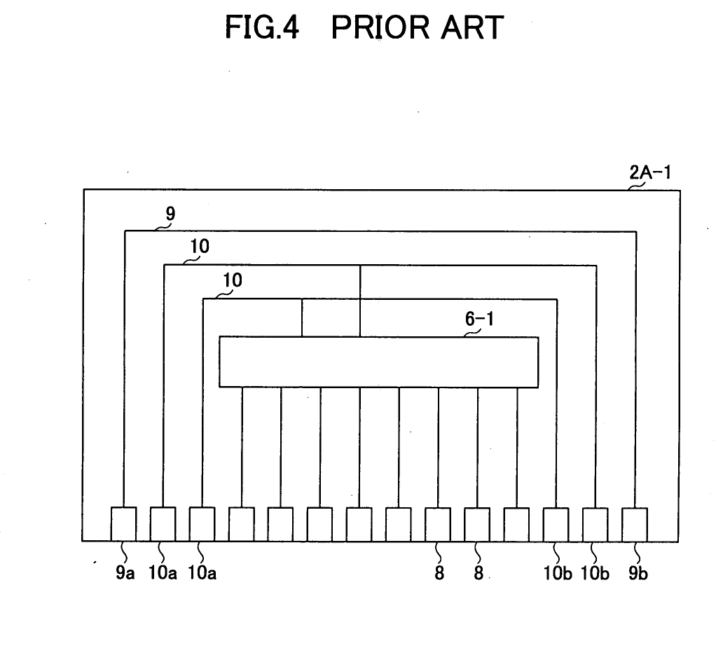

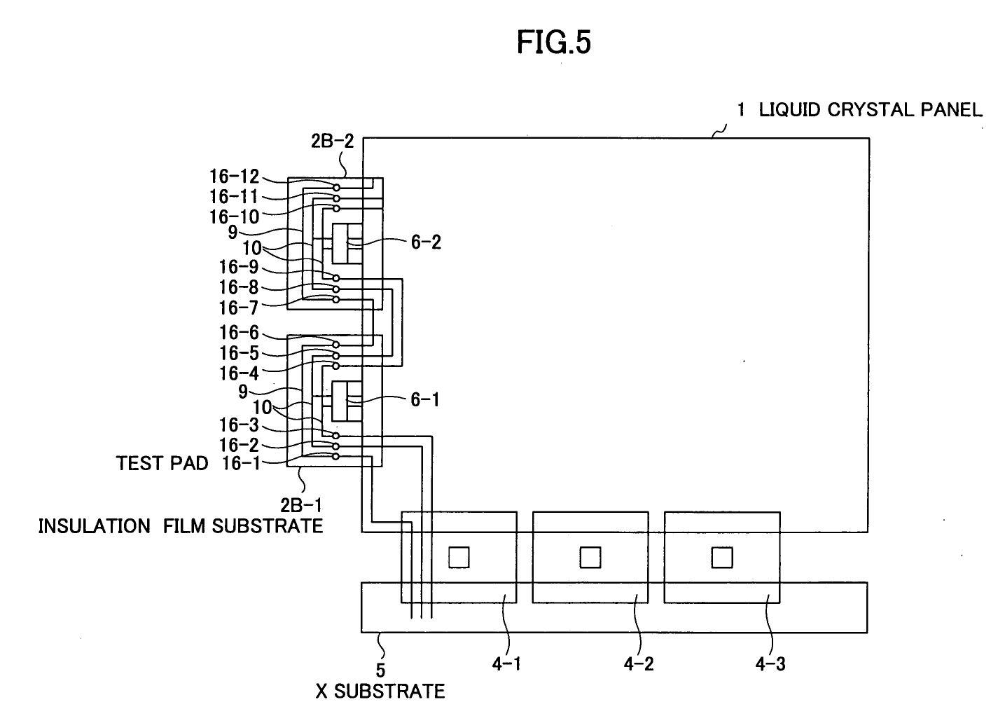

FIG. 5 is a plan view showing a liquid crystal display apparatus according to one embodiment of the present invention. In FIG. 5, the same components as those in FIG. 3 are designated by the same reference numerals, and the description thereof is omitted.

Referring to FIG. 5, a liquid crystal display apparatus according to the present invention is an active matrix substrate configured by forming thin film transistors (TFT) on a glass substrate in the form of a matrix.

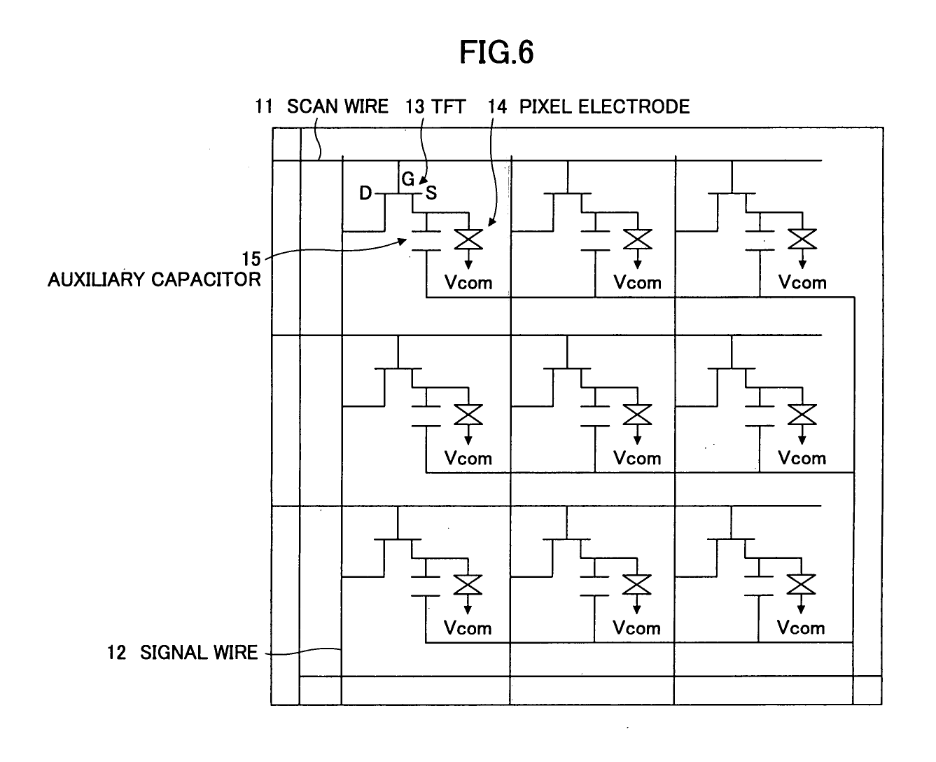

FIG. 6 is a circuit diagram roughly showing transistor circuits formed on a liquid crystal panel 1 in FIG. 5. As shown in FIG. 6, scan wires 11 and signal wires 12 are formed on the active matrix substrate in the form of a matrix. In each area enclosed by the scan wires 11 and the signal wires 12, a thin film transistor (TFT) 13, a pixel electrode 14 and an auxiliary capacitor 15 are formed.

In FIG. 5, insulation film substrates 2B-1 and 2B-2 are connected to the Y axis directional edge of the liquid crystal panel 1, and insulation film substrates 4-1 through 4-3 are connected to the X axis directional edge thereof. Here, the number of insulation film substrates is not limited to the illustration, and an arbitrary number of insulation film substrates may be connected to the liquid crystal panel 1 as needed.

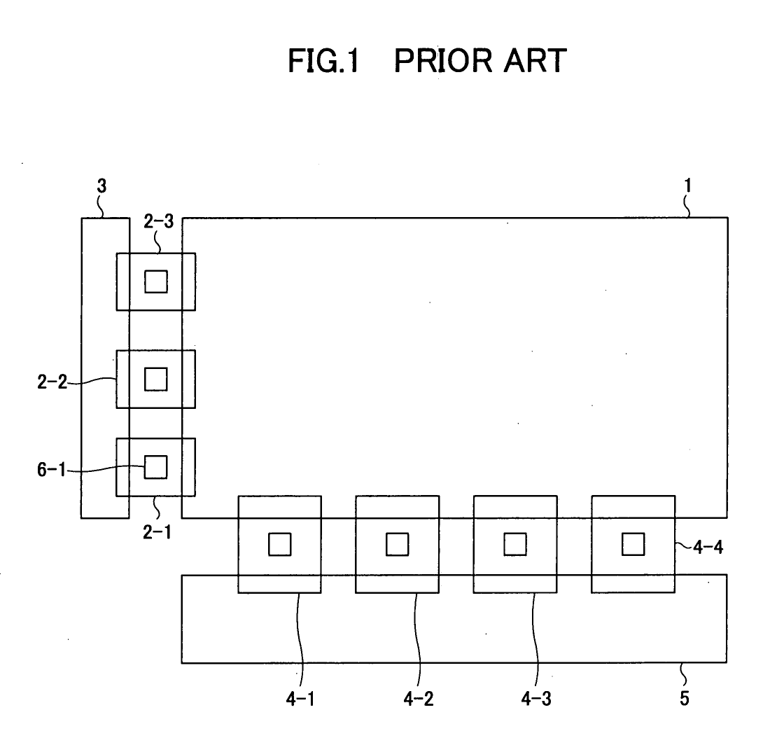

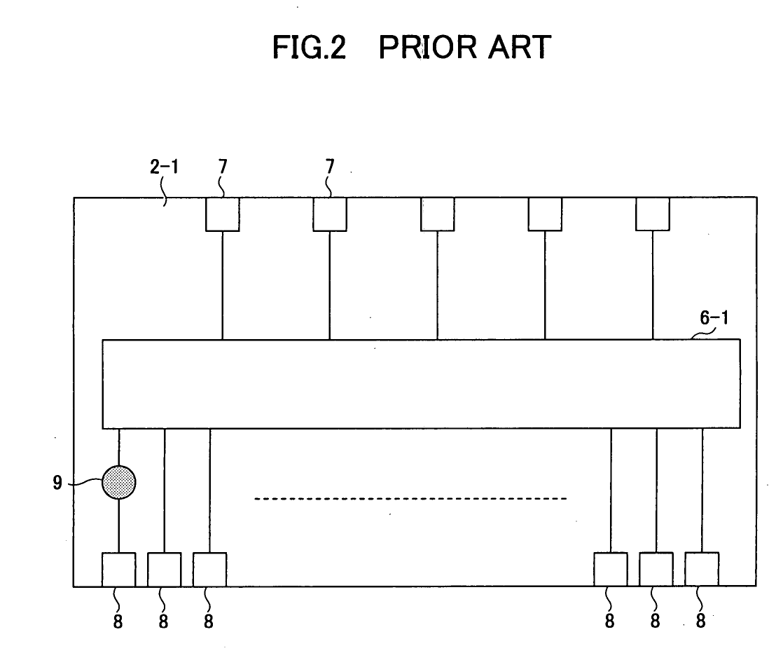

The liquid crystal display apparatus shown in FIG. 5 includes no Y substrate 3 as shown in FIG. 1. Like the liquid crystal substrate shown in FIG. 3, an input signal is supplied from an X substrate 5 to the insulation film substrate 2B-1 via wires of the insulation film substrate 4-1 and the liquid crystal panel 1. Then, the input signal supplied to the insulation film substrate 2B-1 is supplied from the insulation film substrates 2B-1 to the insulation film substrate 2B-2 via a through wire 9 and an input signal wire 10 of the insulation film substrate 2B-1.

The above-mentioned structure is the same as that of the liquid crystal display apparatus shown in FIG. 3. In this embodiment, however, as shown by circles in FIG. 5, test pads 16-1 through 16-12 are provided to the insulation films 2B-1 and 2B-2. The test pads 16-1 through 16-12 are used to detect input signals to the drive ICs 6-1 and 6-2 and the liquid crystal panel 1, and communication between these components are checked via the test pads 16-1 through 16-12.

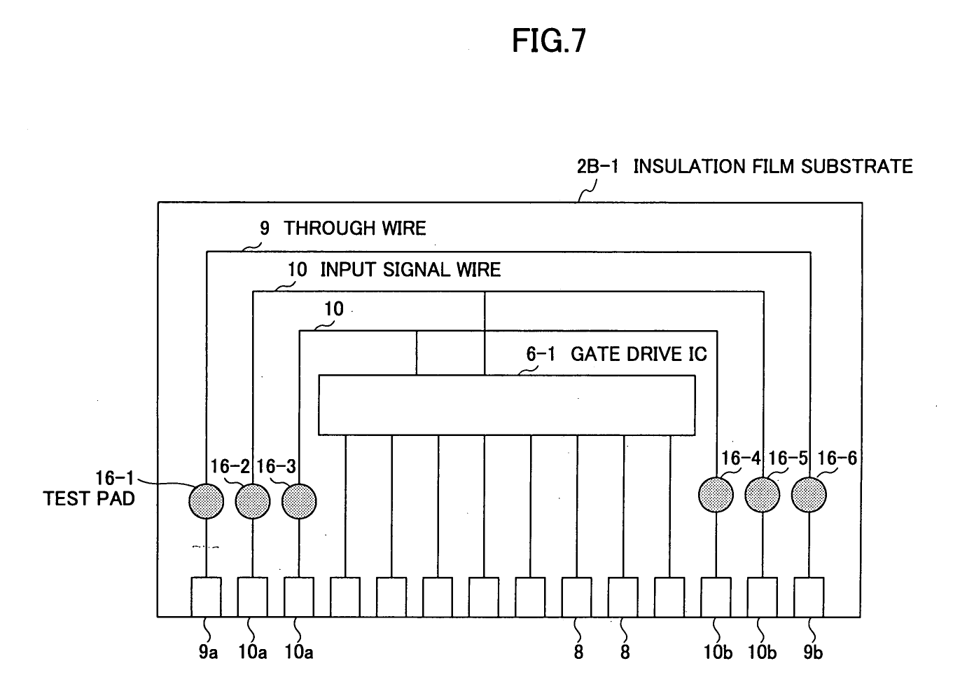

FIG. 7 is a magnified pan view showing the insulation film substrate 2B-1 in FIG. 5. Referring to FIG. 7, the test pad 16-1 is formed in vicinity of an input terminal 9a of the through wire 9, and the test pad 16-6 is formed in vicinity of an input terminal 9b of the through wire 9. Also, the test pad 16-2 is formed in vicinity of an input terminal 10a of the input signal line 10, and the test pas 16-5 is formed in vicinity of an input terminal 10b of the input signal line 10. The other test pads are also formed on the through wire 9 and the input signal lines 10 as in the same structure. Hereinafter, the test pads 16-1 through 16-12 are collectively referred to as a test pad 16.

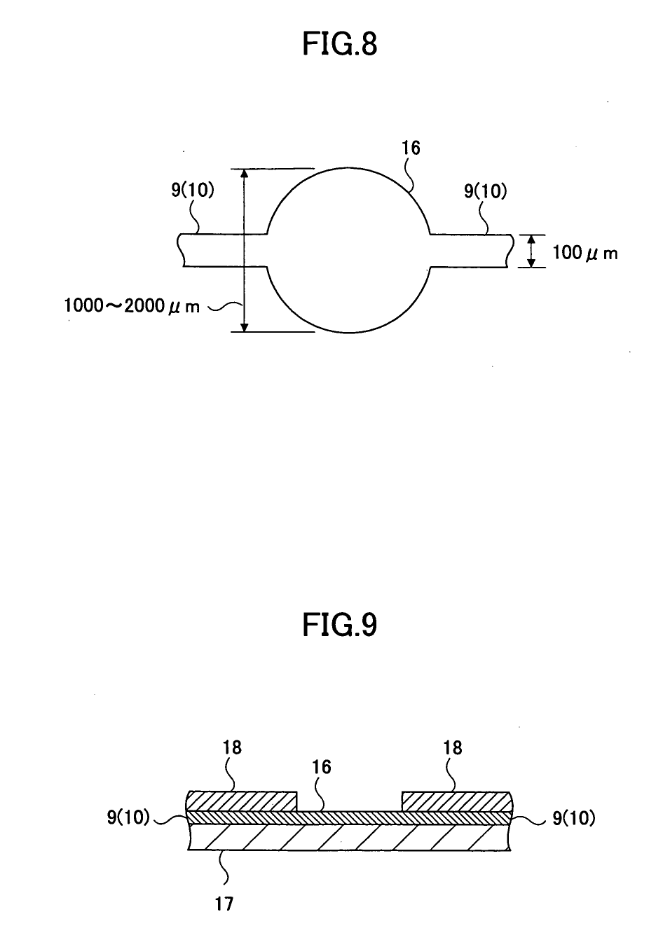

FIG. 8 is a magnified plan view showing the test pad 16. FIG. 9 is a cross-sectional view showing the insulation film substrate 2B-1 with respect to a formation portion of the test pad 16.

Referring to FIG. 8, the test pad 16 is formed, for example, as a circle in the halfway of a patterned wire. Specifically, when a through wire 9 and an input signal line 10 are patterned, a relatively large circle is patterned as a portion corresponding to the test pad 16.

For example, if the through wire 9 and the input signal line 10 have the wire width of 100 μm, the diameter of the test pad 16 is set as a value between 1000 μm and 2000 μm. In such a setting, the test pad 16 has an enough large area, and can become easily connectable with a test probe.

In this embodiment, the test pad 16 is configured as a circle. However, the test pad 16 is not limited to this shape, and can be configured to have an arbitrary shape as long as the test pad 16 has a shape and an area easily connectable to a probe and so on.

Referring to FIG. 9, wires including the through wire 9 and the input signal line 10 can be patterned, for example, through etching of a copper coat attached on the film substrate 17 such as a polyimide film. Accordingly, if a portion of patterned wires is simply fabricated as a circle through etching, for example, it is possible to easily form the test pad 16 without any special processing.

On a film substrate 17, the portion other than the resulting test pad 16 and input and output terminals is covered with an insulation layer 18. Thus, since the test pad 16 can be exposed from the insulation layer 18 under a condition where the insulation film substrate is connected to the liquid crystal panel 1, it is possible to achieve electrical communication by contact with a test probe and so on.

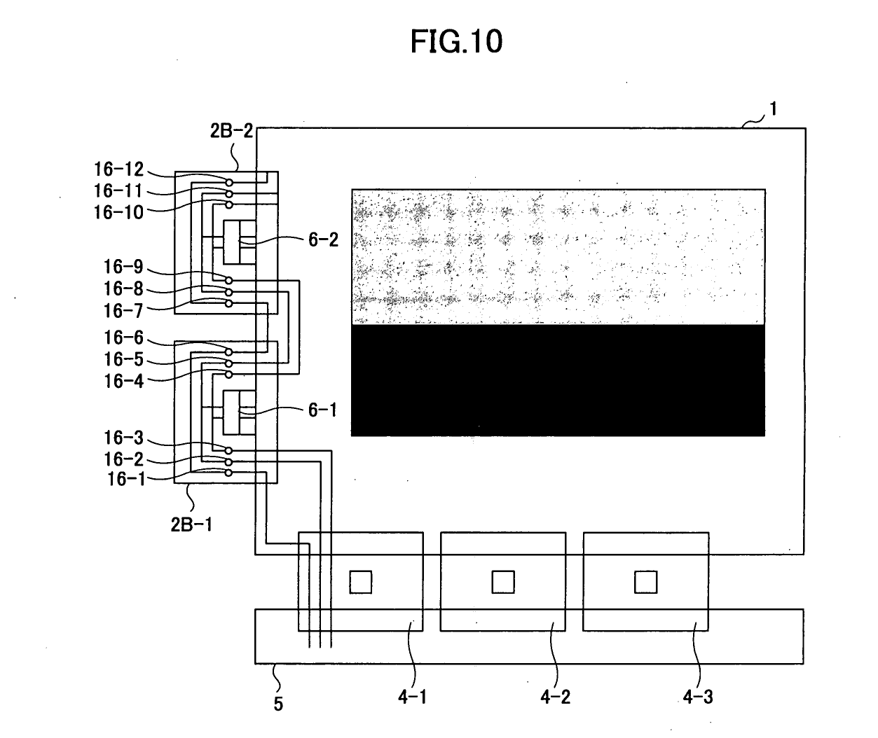

A description is given, with reference to FIG. 10, of a test method for the liquid crystal display apparatus shown in FIG. 5.

FIG. 10 is a diagram to explain a test method for the liquid crystal display apparatus in FIG. 5. In FIG. 10, the same components as those in FIG. 5 are designated by the same reference numerals.

In an example illustrated in FIG. 10, a signal is supplied so that the whole surface of the liquid crystal panel 1 can be displayed uniformly. However, in fact, the liquid crystal panel 1 may erroneously display a target image differently between the upper portion and the lower portion of the display part thereof. In this case, it can be estimated that the error is attributed to either of the insulation film substrates 2B-1 and 2B-2, and it is necessary to identify which insulation film substrate is problematic.

For the purpose of the identification, signal waveforms of the test pads 16-2 through 16-5 and 16-8 through 16-11 on the input signal lines 10 of the gate drive IC 6-1 are observed, and thereby it is possible to identify a connection error portion.

As another cause of the illustrated erroneous displaying, it can be estimated that patterned wires of the liquid crystal panel 1 have high resistance values between the test pads 16-4 and 16-9, between the test pads 16-5 and 16-8, and between the test pads 16-6 and 16-7. Accordingly, it is possible to identify a problematic portion due to high resistance by measuring the resistance values between the test pads 16-4 and 16-9, between the test pads 16-5 and 16-8, and between the test pads 16-6 and 16-7.

Also, in another test method using a test pad, it is possible to detect the cause of an error by observing the waveform of a repair wire and a common electrode wire formed as the through wire 9.

In the patterned wires illustrated in FIG. 5, FIG. 7 and FIG. 10, a plurality of patterned wires are collectively illustrated. However, a much larger number of patterned wires are actually formed. Also, it is preferable to provide a test pad to each of the through wire 9 and the input signal lines 10. However, one test pad may be provided to a plurality of wires because of a limited area.

The present invention is not limited to the specifically disclosed embodiments, and variations and modifications may be made without departing from the scope of the present invention.

What is claimed is:

1. A liquid crystal display apparatus, comprising:
an almost quadrilateral liquid crystal panel having a liquid crystal display part; and
a plurality of first drive IC substrates being aligned along an edge of the liquid crystal panel and connected to the liquid crystal panel, each of the plurality of first drive IC substrates having a first drive IC,
wherein the first drive IC substrate comprises a through wire to connect between distinct terminals of a plurality of terminals aligned along an edge thereof, and a test pad is formed on a portion of the through wire.

2. The liquid crystal display apparatus as claimed in claim 1, wherein the first drive IC substrate further comprises an input signal wire to connect between distinct terminals of the plurality of terminals aligned along the edge thereof, the input signal wire being connected to an input terminal of the first drive IC substrate, and a test pad is formed on a portion of the input signal wire.

3. The liquid crystal display apparatus as claimed in claim 1, wherein the test pad is formed by widening a portion of a patterned wire including a through wire or an input signal wire compared to the other portion thereof.

4. The liquid crystal display apparatus as claimed in claim 1, wherein the liquid crystal panel comprises at least one wire to connect between through wires or input signal wires on adjacent ones of the plurality of first drive IC substrates.

5. The liquid crystal display apparatus as claimed in claim 1, further comprising:
a plurality of second drive IC substrates being aligned along an edge orthogonal to the edge of the liquid crystal panel connected to the plurality of first drive IC substrates and connected to the liquid crystal panel, each of the plurality of second drive IC substrates comprising a second drive IC; and
a signal input substrate being connected to each of the plurality of second drive IC substrates,
wherein a signal is supplied from the signal input substrate to the first IC drive substrate via a wire formed on the signal input substrate, one of the plurality of second drive ICs and the liquid crystal panel.

6. The liquid crystal display apparatus as clamed in claim 1, wherein for each of the plurality of first drive IC substrates, one end of the through wire is connected to an input terminal formed in an outside area of a line of IC signal output terminals formed on an edge side of the first drive IC substrate, and the other end of the through wire is connected to an output terminal formed in the other outside area of the line of the IC signal output terminals.

7. The liquid crystal display apparatus as claimed in claim 1, wherein for each of the plurality of first drive IC substrates, one end of the input signal wire is connected to an input terminal formed in an outside area of a line of IC signal output terminals formed on an edge side of the first drive IC substrate, and the other end of the input signal wire is connected to an output terminal formed in the other outside area of the line of the IC signal output terminals.

8. The liquid crystal display apparatus as claimed in claim 1, wherein the liquid crystal panel is an active matrix substrate on which thin film transistors are formed and arranged in form of a matrix, and the first drive IC substrate is an insulation film substrate and connected to the liquid crystal panel by using anisotropically conductive resin.

9. A liquid crystal display apparatus, comprising:
an almost quadrilateral liquid crystal panel having a liquid crystal display part; and
a plurality of first drive IC substrates being aligned along an edge of the liquid crystal panel and connected to the liquid crystal panel, each of the plurality of first drive IC substrates having a first drive IC,
wherein the first drive IC substrate comprises an input signal wire to connect between distinct terminals of a plurality of terminals aligned along an edge thereof, the input signal wire being connected to an input terminal of the first drive IC, and a test pad is formed on a portion of the input signal wire.

10. The liquid crystal display apparatus as claimed in claim 9, wherein the test pad is formed by widening a portion of a patterned wire including an input signal wire compared to the other portion thereof.

11. The liquid crystal display apparatus as claimed in claim 9, wherein the liquid crystal panel comprises at least one wire to connect between input signal wires on adjacent ones of the plurality of first drive IC substrates.

12. The liquid crystal display apparatus as claimed in claim 9, further comprising:
a plurality of second drive IC substrates being aligned along an edge orthogonal to the edge of the liquid crystal panel connected to the plurality of first drive IC substrates and connected to the liquid crystal panel, each of the plurality of second drive IC substrates comprising a second drive IC; and
a signal input substrate being connected to each of the plurality of second drive IC substrates,
wherein a signal is supplied from the signal input substrate to the first IC drive substrate via a wire formed on the signal input substrate, one of the plurality of second drive ICs and the liquid crystal panel.

13. The liquid crystal display apparatus as clamed in claim 9, wherein for each of the plurality of first drive IC substrates, one end of the through wire is connected to an input terminal formed in an outside area of a line of IC signal output terminals formed on an edge side of the first drive IC substrate, and the other end of the through wire is connected to an output terminal formed in the other outside area of the line of the IC signal output terminals.

14. The liquid crystal display apparatus as claimed in claim 9, wherein for each of the plurality of first drive IC substrates, one end of the input signal wire is connected to an input terminal formed in an outside area of a line of IC signal output terminals formed on an edge side of the first drive IC substrate, and the other end of the input signal wire is connected to an output terminal formed in the other outside area of the line of the IC signal output terminals.

15. The liquid crystal display apparatus as claimed in claim 9, wherein the liquid crystal panel is an active matrix substrate on which thin film transistors are formed and arranged in form of a matrix, and the first drive IC substrate is an insulation film substrate and connected to the liquid crystal panel by using anisotropically conductive resin.
